(19) United States
(12) Patent Application Publication
(10) Pub. No.: US 2011/0010364 A1
(43) Pub. Date: Jan. 13, 2011

(54) GEOGRAPHICAL ITEM IDENTIFICATION

(75) Inventors: Marko Ahtisaari, Helsinki (FI); Matthew Simon, London (GB)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/797,398

(22) Filed: Jun. 9, 2010

(30) Foreign Application Priority Data
Jun. 9, 2009 (FI) 20095642

(51) Int. Cl. G06F 17/30

(52) U.S. Cl. 707/724; 707/749; 707/E17.084; 707/E17.11

(57) ABSTRACT

A location database is maintained with information regarding each of a number of different geographical items in different locations. A user database is also maintained with user records for various users, each user record comprising the user's identification data. In addition, in at least one of the location database and the user database, an identification is maintained of different geographical items which each user has visited. Geographical-item-to-geographical-item similarities are defined between different geographical items based on the user database. User-to-user similarities between the users are defined based on the user database. A weighted combination of the defined geographical-item-to-geographical-item and user-to-user similarities is computed and particularly relevant geographical items in a given location are identified to a user based on the weighted combination.

### CROSS REFERENCE TO RELATED APPLICATIONS

This application claims priority to Finnish Patent Application No. 20095642 filed on Jun. 9, 2009, the entirety of which is incorporated herein by reference.

### TECHNICAL FIELD

The present invention generally relates to identification of geographical items.

### BACKGROUND

Travellers need various local services the quality and properties of which are greatly variable. Without local knowledge, it may be difficult to select e.g. a suitable restaurant according to one's taste and possible dietary restrictions. There are various ways to guide travellers. For instance, travel agencies collect information about common travel destinations and advise their clients as part of their service. However, it has become increasingly common to book travels directly by internet and thus no opportunity arises to discuss about travel destinations with travel agency clerks. Moreover, the clerks may never have been to the destinations of interest, or their visits may have taken place long ago or been made with quite different interests. Time differences may also prevent or hinder seeking further information from people in home country, while language and culture barriers may prevent enquiring information concerning different points of interest in the destination.

There are also numerous printed travel guides and the Internet has also numerous travel stories and recommendations in various sites, blogs, video postings, news articles, chat rooms and discussion groups, among others. Such sources are, however, poorly suited to someone willing to quickly decide where to go at a given instant, accounting for her own preferences. For instance, carrying of travel guides is a physical burden and it may be physically impossible to contact suitably knowledgeable people when information concerning particular location is desired.

It is an object of the invention to address and at least mitigate problems related to travelling in foreign or generally unfamiliar destinations.

### SUMMARY

According to a first exemplary aspect of the invention there is provided a method comprising:

maintaining a location database comprising information regarding each of a number of different geographical items in different locations;

maintaining a user database comprising user records for various users, each user record comprising the user's identification data;

maintaining in at least one of the location database and the user database an identification of different geographical items which each user has visited;

defining geographical-item-to-geographical-item similarities between different geographical items based on the user database;

defining user-to-user similarities between the users based on the user database;

computing a weighted combination of the defined geographical-item-to-geographical-item and user-to-user similarities; and

identifying particularly relevant geographical items in a given location to a user based on the weighted combination.

It is recognised that there are various other fields or approaches to identifying desired information in general or in particular with relation to travel guiding.

Amazon.com use the collective preferences of their whole user base to find similar items for a given item in their shopping service. This method is based on average users. There, a server generates additional recommendations using a previously-generated table which maps items to lists of similar items. The similarities reflected by the table are based on the collective interests of the community of users.

TripAdvisor is a web service that collects reviews of hotels and other travel locations. The service ranks and presents lists of these locations according an aggregate of scores given by their site's users. The relationships amongst these users are not collected on the site, and so the ranking does not consider them.

It is also appreciated that normally online services that give recommendations have used a combination of metrics (e.g. star-ratings given by users, amount of web traffic to a location's page, placement paid for by vendors) without due regard to the factors of influence that exist in normal social relationships. For example, a particular group of friends may dislike a restaurant because of their common preferences or history, even if that restaurant were popular and highly rated by their visitors and critics. In order to identify particularly relevant points of interests to an individual (as opposed to an average user) from a list of alternatives, attention should be paid to factors such as social influence, shared taste, and preference for mainstream versus the unusual. Such concepts are typically hard to translate into a computer model.

However, the inventors have perceived these needs and challenges and address them with different aspects and embodiments of this invention.

The method may further comprise allowing different users to determine access rights indicative of which other users are allowed to access to their travel data; and using the access rights in defining the user-to-user similarities.

The method may further comprise producing a number of web pages corresponding to different geographical items based on the information regarding the geographical items concerned.

The method may further comprise receiving a request for identifying of relevant geographical items in a given location from requesting user;

computing for the requesting user the weighted combination of the defined geographical-item-to-geographical-item and user-to-user similarities;

identifying particularly relevant geographical items in a given location to the requesting user based on the weighted combination; and

providing the requesting user with the identified particularly relevant geographical items.

The geographical items may be different areas of towns or cities.

The method may further comprise determining particularly relevant points of interests for a given user in a particular area of town or city, the points of interests being referred to as POIs; the determination comprising the steps of:

defining POI-to-POI similarities between different POIs; and

computing a weighted combination based on the defined POI-to-POI similarities and the user-to-user similarities.

According to a second exemplary aspect there is provided an apparatus comprising:

a communication port for communicating with different user devices;

characterized in that the apparatus comprises:

a memory comprising:

a location database comprising information regarding each of a number of different geographical items in different locations;

a user database comprising user records for various users, each user record comprising the user's identification data; and the memory comprising:

in at least one of the location database and the user database an identification of different geographical items which each user has visited;

and the apparatus further comprising a processor for controlling the operation of the apparatus, configured to control the apparatus to perform:

defining geographical-item-to-geographical-item similarities between different geographical items based on the user database;

defining user-to-user similarities between the users based on the user database;

computing a weighted combination of the defined geographical-item-to-geographical-item and user-to-user similarities; and

identifying particularly relevant geographical items in a given location to a user based on the weighted combination.

According to a third aspect of the invention there is provided a computer program stored in a memory medium comprising computer executable program code for controlling an apparatus, comprising:

computer executable program code configured to cause the apparatus to maintain a location database comprising information regarding each of a number of different geographical items in different locations;

computer executable program code configured to cause the apparatus to maintain a user database comprising user records for various users, each user record comprising the user's identification data;

computer executable program code configured to cause the apparatus to maintain in at least one of the location database and the user database an identification of different geographical items which each user has visited;

computer executable program code configured to cause the apparatus to define geographical-item-to-geographical-item similarities between different geographical items based on the user database;

computer executable program code configured to cause the apparatus to define user-to-user similarities between the users based on the user database;

computer executable program code configured to cause the apparatus to compute a weighted combination of the defined geographical-item-to-geographical-item and user-to-user similarities; and

computer executable program code configured to cause the apparatus to identify particularly relevant geographical items in a given location to a user based on the weighted combination.

Different aspects and embodiments of the present invention have been illustrated in the foregoing. Some embodiments may be presented in this document only with reference to certain exemplary aspects of the invention. It should be appreciated that corresponding embodiments may apply to other exemplary aspects as well.

### BRIEF DESCRIPTION OF THE DRAWINGS

The invention will be described, by way of example only, with reference to the accompanying drawings, in which:

FIG. 1 shows a schematic drawing of a system according to an embodiment of the invention;

FIG. 2 shows a block diagram of a user terminal according to an embodiment of the invention;

FIG. 3 shows a block diagram of a server according to an embodiment of the invention;

FIG. 4 a block diagram illustrating basic processes in the server of FIG. 3;

FIG. 5 shows a table demonstrating a social atlas;

FIG. 6 shows a process for identifying particular points of interests in a given location;

FIG. 7 shows an example of data structures used in an embodiment of the invention;

FIG. 8 shows a graph for illustrating use of social weighting in identifying particularly relevant points of interests; and

FIG. 9 shows a process according to an embodiment of the invention.

### DETAILED DESCRIPTION

In the following description, like numbers denote like elements.

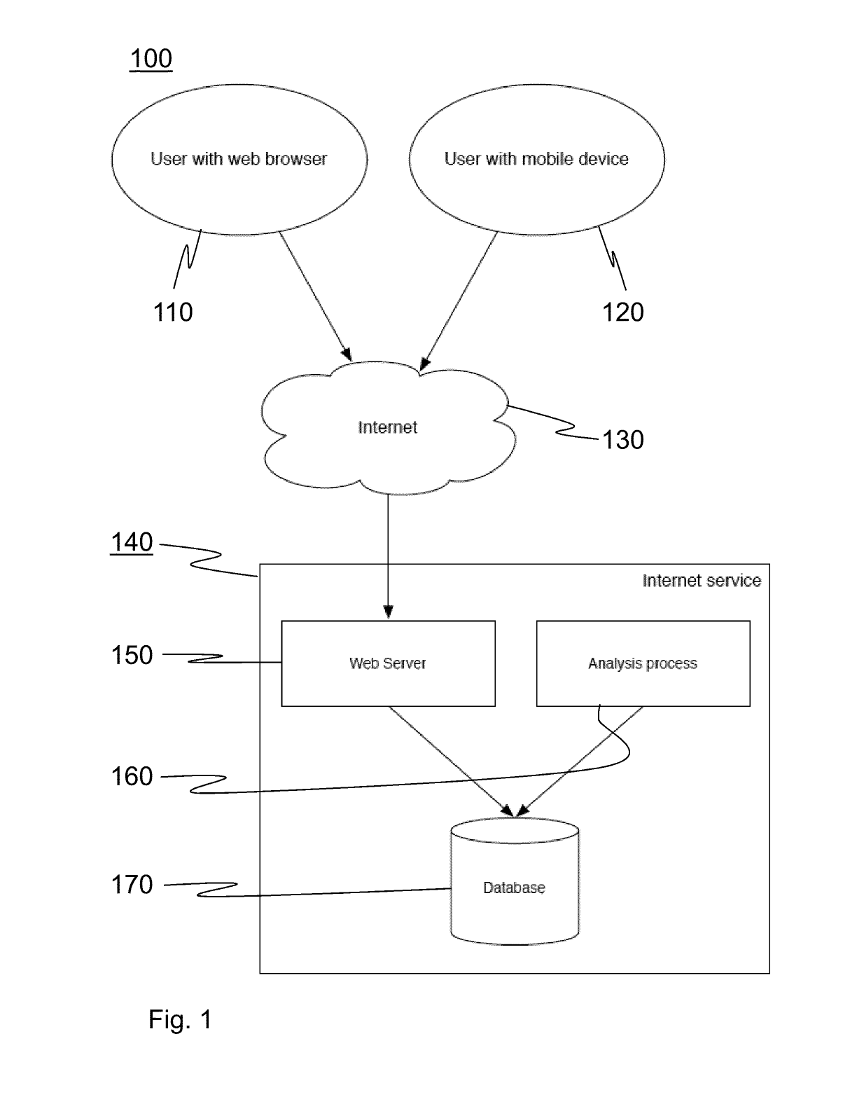

FIG. 1 shows a schematic drawing of a system 100 according to an embodiment of the invention. The system comprises a fixed user station 110 that represents a user and a web browser, a mobile user with a mobile device 120, an access network such as the Internet 130, and one or more service provider domains 140. The service provider domain 140 comprises as functional units a web server 150, an analysis process 160 (run by the web server or another server) and a database 170.

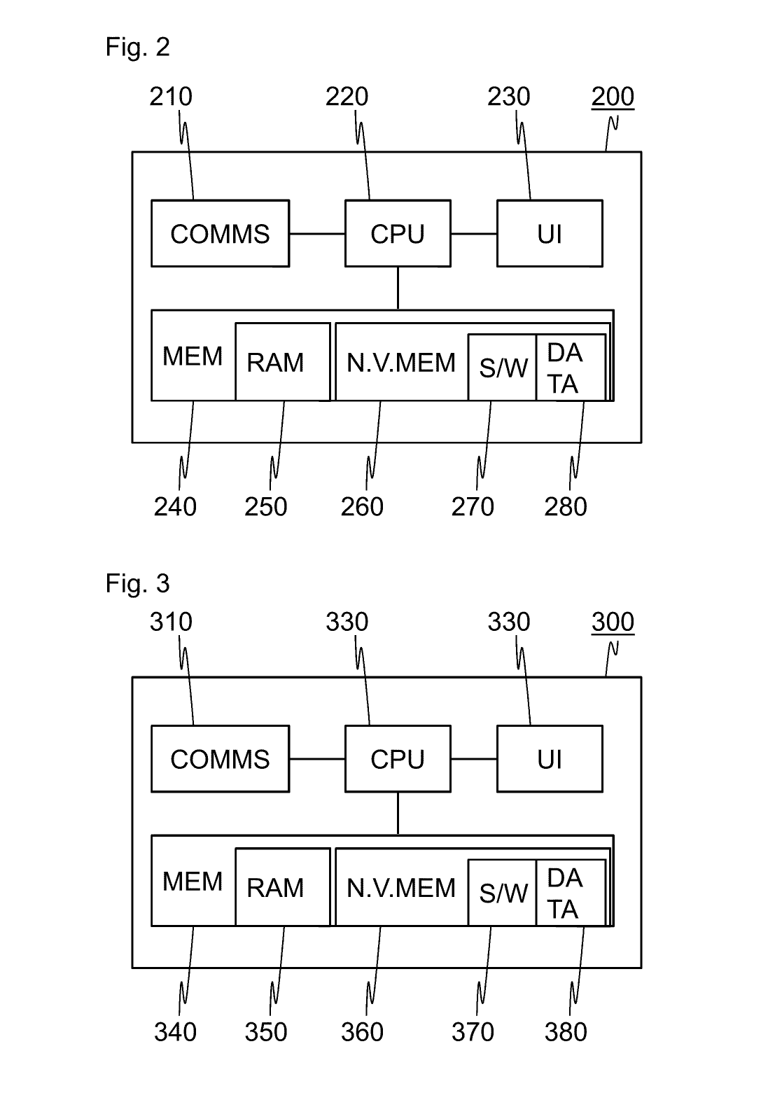

FIG. 2 shows a block diagram of a user terminal 200 according to an embodiment of the invention. The user terminal 200 may be a mobile terminal, a fixed terminal, or capable of both mobile access and using fixed access to the access network 130. The terminal 200 comprises a communications block 210 for data access, a processor 220 such as a central processing unit for controlling the operation of the terminal 200, a user interface for providing information to the user and receiving user instructions (with e.g. a display, audio output, keypad, keyboard, cursor controller, touch screen, speech synthesis circuitry, speech recognition circuitry and/or microphone). The terminal 200 further comprises a memory 240 with a work memory 250 such as a random access memory and a non-volatile memory 260 configured to store software 270 i.e. instructions for controlling the processor 220 and different types of user data 280 such as user preferences and settings related to the user of the terminal 200 or to the user.

FIG. 3 shows a block diagram of a server 300 according to an embodiment of the invention. The server 300 comprises a communications block 310 for communicating with network terminals 200, a processor 320 such as a central processing unit for controlling the operation of the server 300, a user interface for providing information to the user and receiving user instructions (with e.g. a display, audio output, keypad, keyboard, cursor controller, touch screen, speech synthesis circuitry, speech recognition circuitry and/or microphone). The server 300 further comprises a memory 340 with a work memory 350 such as a random access memory and a non-volatile memory 360 configured to store software 370 i.e. instructions for controlling the processor 320 and different types of data 380 such as databases, customisation settings, and user authentication data.

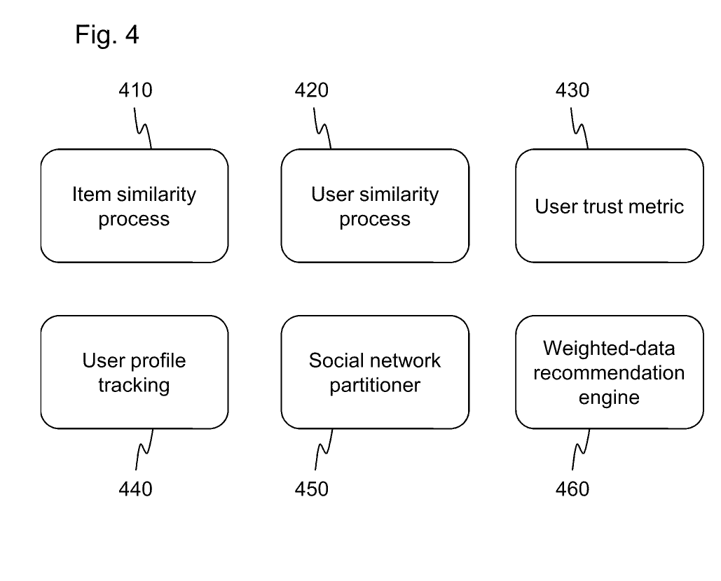

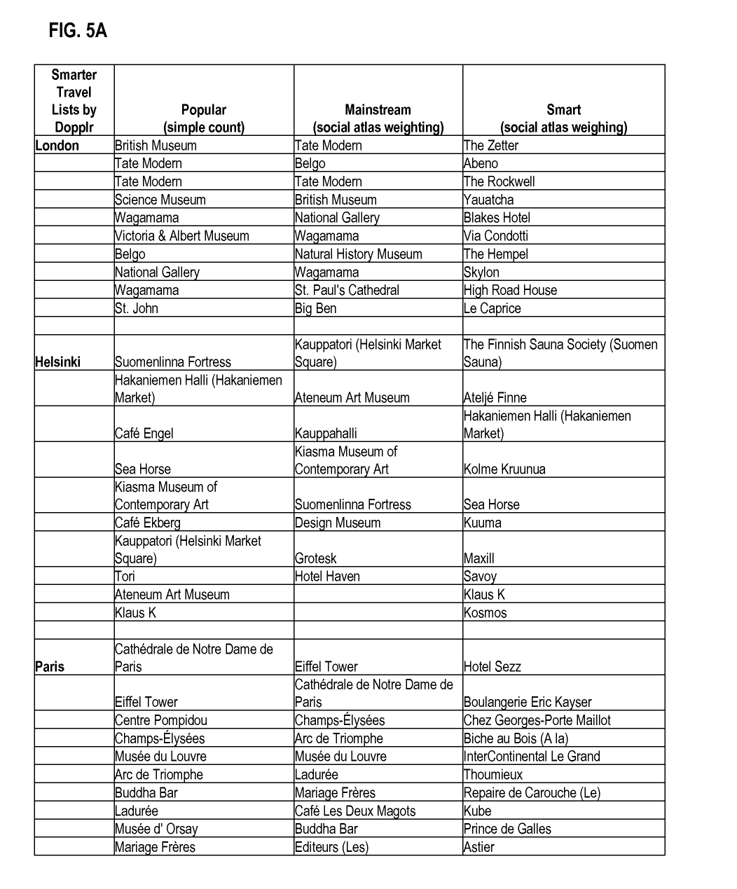

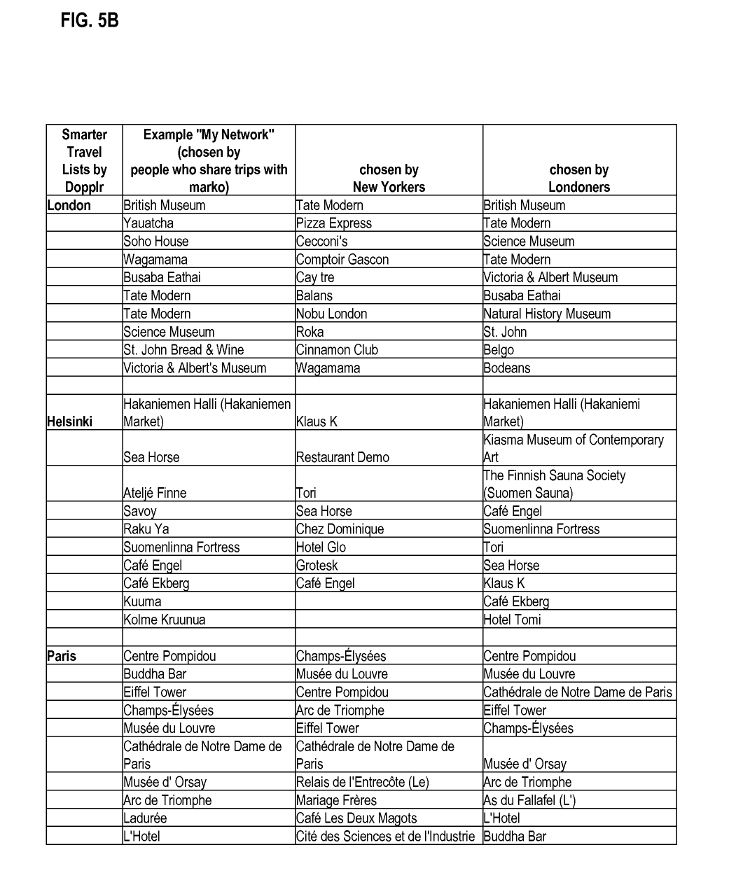

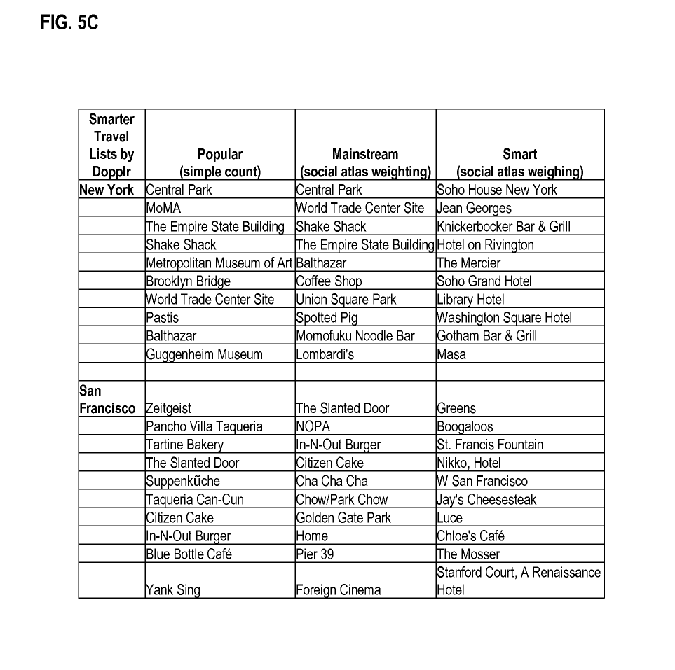

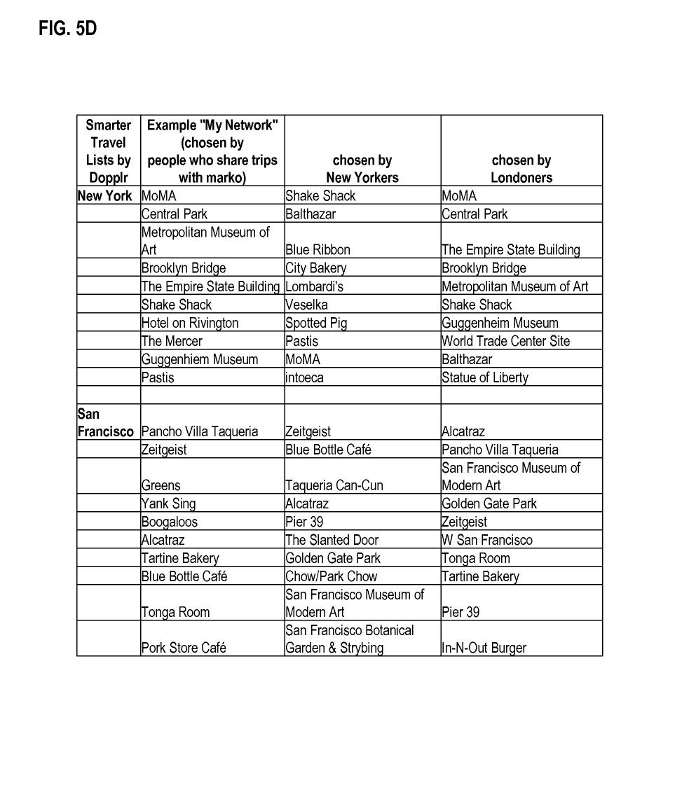

FIG. 4 a block diagram illustrating basic processes in the server of FIG. 3. The basic processes presented in FIG. 4 are illustrative of particular operations according to embodiments of the invention. Some well-known typical processes such as user account administration is omitted in sake of brevity. The processes shown in FIG. 4 are performed at least in part in parallel without waiting for the completion of one process prior to starting of another process. Moreover, the server 300 typically serves a large number of simultaneous users so that a number of instances of each process typically occurs. Next turning to the basic processes, there is an item-to-item similarity process in which corresponding items or points of interest are being identified from different locations. This process may be based on user behavioural models as is also described further in the following description. There is also a user similarity process 420 configured to determine similar users based on the recorded data concerning the users. Moreover, there is a user trust metric or influentiality process 430 in which trustworthiness or influentiality of different users is determined, user profile tracking 440 in which basically different user's travelling and travelling preferences are being monitored and accrued. In this process, particular users may be allowed to define other users with whom their travel data may be shared. There is also a social network partitioner process 450 configured to determine different subsets of socially associated users. This process may be based on the results of the user similarity process 420 and user profile tracking process 440. A weighted-data recommendation engine or process 460 is provided to calculate particularly weighted recommendations for likely relevant points of interests to different users. The engine may be configured to employ the determined social networks or relevant network subsets and the item-to-item similarities and to produce results classified into different groups such as most popular, mainstream, socially weighted by the influentiality of sources of different recommendations, target user's own network's weighting, and/or based on other users from common home city or country.

The service is accessed by users over the internet. Typically, the users interact with the service using a web browser, initially to register a user account and then to add their travel plans.

Users may use a local service application on their mobile devices. This application displays service information in the form of maps showing places of interest, and lists of travel plans of the user and of those who have shared their travel information with the user. This information is transmitted on request to the service application over the internet.

The users may indicate that they have visited a place of interest, or enter information on a place of interest not currently listed. In either case, this data is transmitted over the internet to the service's servers.

The internet service is accessed via a set of web servers, which serve data in response to requests from a user's web browser or mobile device application.

The application's data is read from and written to a database which sits on the same local network as the web servers.

A separate process runs batch jobs to analyse service data for patterns and metrics. The results of this analysis is written back to the database for use by the web servers.

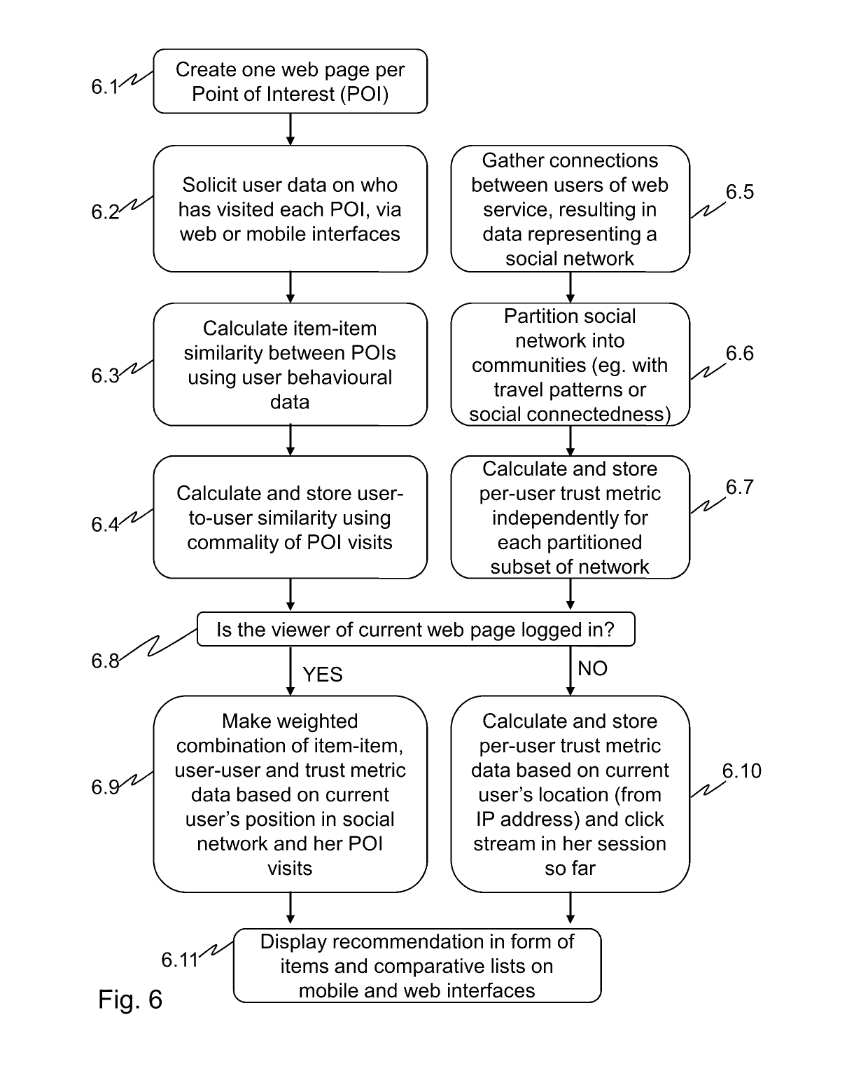

FIG. 6 illustrates a process for identifying particular points of interests in a given location. The process comprises following main steps shown in FIG. 6:

6.1 Create one web page per Point of Interest (POI)

6.2 Solicit user data on users who have visited each POI

6.3 Calculate item-item similarity between POIs using user behaviour data

6.4 Calculate user-user similarity between users using commonality of POI visits

6.5 Detect social network among the users

6.6 Partition the social network into subsets

6.7 Calculate and store per-user trust metric independently for each subset

6.8 Check if particular user is logged in the service

6.9 If yes, make a weighted combination of item-item, user-user and trust metric data based on user's location, user's position in the social network and POI data from other users in the social network

6.10 If no, make a weighted combination of item-item, user-user and trust metric data based on user's location (from IP address) and usage history in the session so far

6.11 Display recommendation

In step 6.1, the POIs are real-world places in a particular location such as hotels, restaurants and places to visit or explore (e.g. museums, marketplaces). A unique identifier is assigned to each POI, e.g. ‘thai-pavilion’. This identifier and the real-world city location of the POI are used together to form a unique web URL for each POI, e.g. http://www.dopplr.com/place/gb/london/eat/thai-pavilion. Hence, meaningful web addresses are formed to users. Moreover, the providing of individual URLs to different POIs enables simple and efficient monitoring how different users access various POIs.

In step 6.2, Information is gathered about who has visited each POI. Normally, the users access the service via fixed or mobile terminals. When a user visits the web pages of a POI or more generally accesses a POI record in a database of different POIs, the user is presented with an interface allowing to register in the service having been to that place. In a preferred embodiment, the user is allowed to perform this registration with a dedicated first control using a single click. A dedicated second control after using of the first control or in parallel with the first control is provided to indicate a rating for the visited POI (e.g. whether it was favoured or not or how highly it was liked on a scale of one to three, for instance). A third control may be provided to signal to the service the data to that the user has not visited the POI. These data are stored in the location database in association with the POI in question.

In one embodiment of the invention, the user accesses the service with a mobile interface and the user is presented with a map of the POIs. The service makes use of positioning capabilities (e.g. GPS) of the user's equipment to locate the map on the user's current location. Also in this embodiment, the user identifies a visit by making a selection (e.g. by tapping a point on map with a touch screen) to represent a visit. On recording the visit, location data of the user's equipment may also be used to verify or detect physical presence at the POI. This data is then transmitted to the location database in association with the POI in question.

In step 6.3, an item-to-item similarity is calculated between different POIs using behaviour data of the users. Taking the user-visit data for each POI, a collaborative-filtering index is built of the similarity between POIs based on the overlap of tastes between users who have made the visits. Collaborative filtering may be employed in this step. In result, a list is obtained for each POI of other POIs that are likely to be preferred by users who have visited the POI. This list is stored in the location database in association with each POI.

The item-to-item list may prepared in a batch operation at times when the service usage is lower. Alternatively, or additionally, the item-to-item list may be prepared or updated on obtaining data from the users, e.g. in connection with step 6.2. In this manner, the location database may be kept up-to-date when user's feed further information in the service.

In step 6.4, user-to-user similarity is calculated between users using commonality of POI visits. Taking the user-visit data for each POI, the service builds a collaborative-filtering index of the similarity between users based on the overlap of tastes between users who have made visits to each POI. The taste is indirectly and automatically detecting from the types of POIs that the users have preferred in their own data entries to the service (in connection with step 6.2). This step results in a list for each user of other users who have similar POI visit habits to them. This list is stored in the user database in association with each POI.

In step 6.5, connections are gathered between users of web service, resulting in data representing a social network. The service enables the users to share travel plans with other users. Users explicitly choose whom they allow sharing of their travel plans. The social network or graph of connections between users that results is assumed to model the real-life social network between those users. This graph is stored in the database.

In step 6.6, the social network is partitioned into subsets or communities. The partitioning is carried out using e.g. travel patterns or social connectedness. Let us considered from the point of view of the mathematics of graph theory that a social network is a directed, labelled graph. Highly-connected users in this graph are assumed to have a higher probability of being trusted by other users than unconnected users. However, the social connections represented service are assumed not presumed to represent a single community, but instead a number of communities whose members have social connections of varying strength.

In order to separate out these communities for the purposes of calculating a metric of influence for each individual, a graph-partitioning algorithm such as that implemented by METIS (see http://glaros.dtc.umn.edu/gkhome/metis/metis/overview) is used to divide the social graph into a number of partitioned modules. Each user will be a member of some module and this community or these communities are recorded in their database records.

In step 6.7, the service calculates and stores per-user trust metric independently for each partitioned subset of the social network. In order to derive an influence metric per user, a standard centrality calculation is performed (see e.g. http://en.wikipedia.org/wiki/Centrality) for each user, independently for each partitioned module of the social graph. Then, each user's resulting score is stored in their record in the user database.

In step 6.8 it is checked whether the viewer of current web page is logged in? If yes, the process continue from step 6.9, otherwise the process advances to step 6.10.

In step 6.9 a weighted combination is made of item-item, user-user and influence metric data based on current user's position in the social network and their POI visits. This step may involve following sub-steps:

Step A: Take the profile of the currently logged-in user and consider in particular: 1. history of travel destinations. 2. history of POI visits. 3. home city and country. 4. user-user similarity list derived in step 6.4. 5. the other users with common travel information. 6. the subset or community of her social graph (see 6.6 above).

Step B: Consider the POI being viewed, or the current user goal (e.g. a search for a good place to eat in London). Derive candidate lists of similar users and similar POIs. Apply a weighting to rank these lists using the social network influence metric for each user's visit data being considered. Apply a double-weighting if a user is in the immediate social network of the viewing user, or a slightly increased weighting if they are in the same social network module of the viewing user. If applicable for the current user's target, apply contextual filters to the POIs being considered, such as “only consider data from users whose home city is New York”.

After step 6.9 the process continues to step 611 to provide results to the user.

In step 6.10, a weighted combination is made of the item-to-item, user-to-user and influence metric data based on user's location (e.g. as obtained from IP address) and click stream in the user's session so far. As there is no database record available for the user to give an influence metric, history of travel and POI visits for the current viewer, the service creates a “stereotype” user record based on observed web traffic from the user's current web session. The user's IP address is resolved to a city or country using a Geographical IP lookup service such as the GeoIP. The user's browsing history is used to consider any POI pages viewed on the service as if such POIs had been visited by the user. Using this incomplete user data and the item-item similarities previously calculated, but without the influence-metric weighting from the social graph, the process jumps to sub-step B of step 6.9 described in the foregoing.

In step 6.11, a recommendation or a particularly relevant set of POIs in the form of items and comparative lists is displayed on to the user.

Based on the current POI being viewed, or the travel information being entered or queried, the user is provided with one or more lists of POIs that are found suitable for the user. These lists are presented with a prose or explanation of the link to the suggested POIs to motivate and explain the composition of the list. The prose may involve an explanation such as “people who stay at this hotel like to eat at these restaurants”, or “people from New York like to explore these places when visiting Helsinki”, or “two people you know [with their names] with similar travel habits to you like to stay in this part of town when visiting Berlin”.

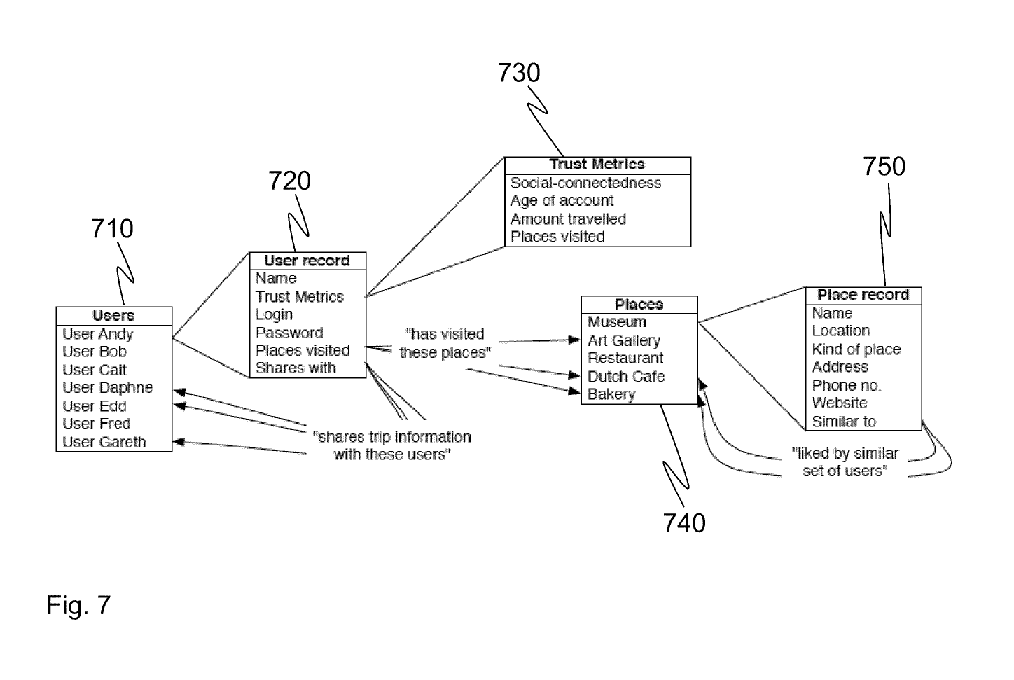

FIG. 7 shows an example of data structures used in an embodiment of the invention. A user database 710 holds a number of user records 720. The user records comprise a number of user related data fields such as name, trust metrics 730, login, password, visited places (or indexes thereof), and sharing information (identification of other people with whom the user's data may be shared). The trust metrics involve parameters such as social connectedness (e.g. as measured by a number of other users' records allowing sharing information with the concerned user), and visited places (e.g. a number of places the user has visited in total or per trip). A location database 740 comprises a number of place records 750 comprising particulars of each point of interest, the particulars including contact data of the POI, website information and a similarity data field. The similarity data field comprises identifiers of other place records 750 that have been preferred by similar set of users.

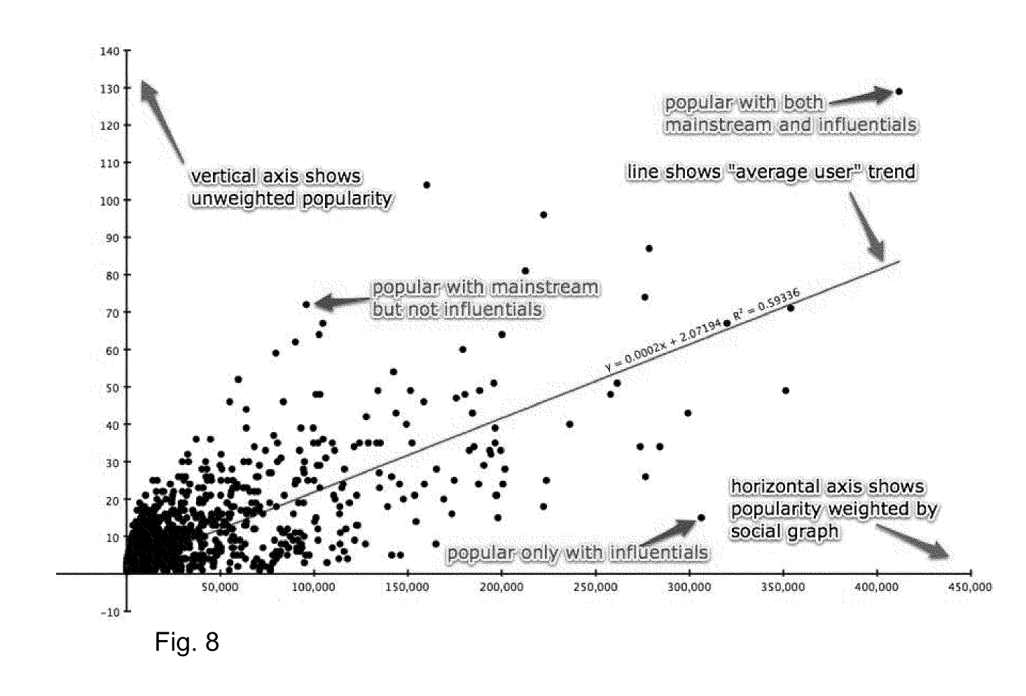

FIG. 8 shows a graph for illustrating use of social weighting in identifying particularly relevant points of interests. This graph shows a scatter plot comparing the “absolute score” of a place of interest to its “weighted score”.

An “absolute score” is calculated by a simple count of how many users have visited this place.

A “weighted score” is calculated by summing a weighted score for each place of interest, customised for the user viewing the information. Customisation may involve, for example, a multiplier based on how trusted the visitor to the place is by the user viewing the information, or a multiplier based on how socially-connected the visitor is in the social graph.

The further towards the top-right of the diagram a place is plotted, the more generally popular amongst both mainstream and trustworthy or influential individuals it is. A trend-line is shown to demonstrate this area of the graph.

A place that is shown towards the top-left of the scatter plot is popular with the mainstream of users, but their weighting for this context is not strong, therefore this may be considered an “obvious” recommendation.

A place that is shown towards the bottom-right of the scatter plot is not popular with users in general, but those users that have visited this place are considered influential or trustworthy according to the metric used. Therefore this place may be considered an “undiscovered gem” or “in the know” location.

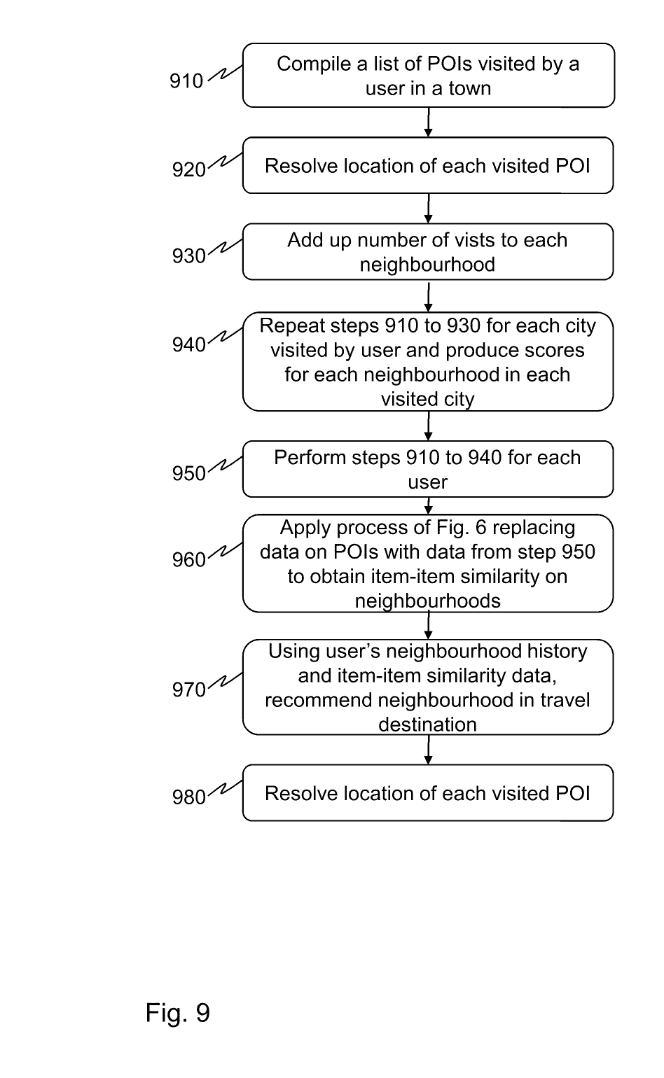

FIG. 9 shows a process according to an embodiment of the invention. Consider the process described in FIG. 6 and associated description. By following that process described with reference to FIG. 6, we obtain a number of POI recommendations. The process described here with reference to FIG. 9 applies the same process to a different set of processed data to obtain recommendations of areas of cities that a traveller might enjoy visiting.

FIG. 9 illustrates the following steps:

910: Compile a list of POIs visited by a user for a particular town. Look up the latitude and longitude coordinate of each POI.

920: For each POI, look up what city neighbourhood that latitude/longitude point is in, using a geography “gazetteer” dataset such as that available from http://www.geonames.org/ or http://code.flickr.com/blog/2009/05/21/flickr-shapefiles-public-dataset-10/

930: Add up the number of visits to each neighbourhood. For example, for San Francisco this might result in a table such as: “Downtown: 5. Castro: 7. Noe Valley: 1. Japantown: 1. Mission: 2”

940: Perform steps 910 to 930 for each city the user has visited, resulting in a number of “scores” for each neighbourhood in each city visited.

When the service is in use and the data on places and users is readily compiled, in an embodiment of the invention the service simply updates the user database 710 when new entries are received from users. However, to initialise the databases before the service is in its established state, step 950 repeats the process of steps 910 to 940 for each user.

960: Apply the process described with reference to FIG. 6, replacing the data on POIs described there with the data calculated in step 950, obtaining item-item similarity on neighbourhoods.

970: When a user intends to travel to a new city, use their neighbourhood history and the item-item similarity data to recommend which neighbourhood of this new city they should visit, book a hotel or eat in.

980: For the recommended neighbourhoods, display to the user the most popular POIs in that neighbourhood.

The embodiments described in the foregoing provide numerous advantages to a traveller over prior known techniques. As opposed to travel guides, there is no need to carry along heavy, space consuming and potentially outdated information. Moreover, by automatically adapting information gathered from the users and weighting the data based on tracked user behaviour, it may be possible to identify likely relevant and rapidly updating data for benefit of a traveller. The provided service is also very easy and fast to use and simple to deploy with generally available software applications such as web browsers.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the scope and spirit of the appended patent claims.

1. A method comprising facilitating access to at least one interface configured to allow access to at least one service, the at least one service configured to perform at least the following:
determining to retrieve user behavior data relating to visitations of at least two of geographical items;
determining at least a first similarity for different ones of the geographical items based at least in part on the user behavior data;
determining at least a second similarity for at least two users based on commonality of the geographical items;
determining location of at least one of the plurality of users; and
determining a quantity based at least in part on the first similarity and at least in part on the second similarity, wherein the quantity comprises an indication of relevance of the geographical items to the location of at least one user.

2. A method according to claim 1, wherein the quantity is a score that includes a weighted combination of the first similarity and the second similarity.

3. A method according to claim 1, further comprising:
determining to create a web page for each of the geographical items; and
determining to track the number of the visitations to the geographical items via the corresponding one of the web pages.

4. A method according to claim 3, further comprising:
determining to receive confirmation of one or more of the visitations based on detection of presence of a user equipment at the corresponding geographical item.

5. A method according to claim 1, further comprising:
determining to rank the geographical items using the quantity.

6. A method according to claim 1, wherein a portion of the users is associated with a social network, the method further comprising:
determining an influence metric for each user in the social network, wherein the quantity is further based on the influence metric.

7. A method according to claim 1, wherein the geographical items include areas of a town or a city.

8. An apparatus comprising:
a processor; and
a memory including computer program code for one or more programs,
the memory and the computer program code configured to, with the processor, cause the apparatus to perform at least the following,
determine to retrieve user behavior data relating to visitations of at least two of geographical items;
determine at least a first similarity for different ones of the geographical items based at least in part on the user behavior data;
determine at least a second similarity for at least two users based on commonality of the geographical items;
determine location of at least one of the plurality of users; and
determine a quantity based at least in part on the first similarity and at least in part on the second similarity, wherein the quantity comprises an indication of relevance of the geographical items to the location of at least one user.

9. An apparatus according to claim 8, wherein the quantity is a score that includes a weighted combination of the first similarity and the second similarity.

10. An apparatus according to claim 8, wherein the apparatus is further caused to:
determine to create a web page for each of the geographical items; and
determine to track the number of the visitations to the geographical items via the corresponding one of the web pages.

11. An apparatus according to claim 10, wherein the apparatus is further caused to:
determine to receive confirmation of one or more of the visitations based on detection of presence of a user equipment at the corresponding geographical item.

12. An apparatus according to claim 8, further comprising:
determine to rank the geographical items using the quantity.

13. An apparatus according to claim 8, wherein a portion of the users is associated with a social network, and the apparatus is further caused to:
determine an influence metric for each user in the social network, wherein the quantity is further based on the influence metric.

14. An apparatus according to claim 8, wherein the geographical items include areas of a town or a city.

15. A method comprising:
determining to access a web page corresponding to a geographical item; and
determining to register a visit by a user to the geographical item via the web page,
wherein the visit is tracked and used to obtain a score to indicate relevance of the geographical item to a given location of the user or another user,
wherein the score is further based on similarity of the geographical item to other geographical items based on behavior data of the user, and similarity of the user with the other user based on commonality of the geographical items.

16. A method according to claim 15, wherein the score includes a weighted combination of the similarities.

17. A method according to claim 15, further comprising:
determining to receive confirmation of the visit based on detection of presence of a user equipment of the user at the geographical item.

18. An apparatus comprising:
a processor; and
a memory including computer program code for one or more programs,
the memory and the computer program code configured to, with the processor, cause the apparatus to perform at least the following,
determine to access a web page corresponding to a geographical item, and
determine to register a visit by a user to the geographical item via the web page,
wherein the visit is tracked and used to obtain a score to indicate relevance of the geographical item to a given location of the user or another user,
wherein the score is further based similarity of the geographical item to other geographical items based on behavior data of the user, and similarity of the user with the other user based on commonality of the geographical items.

19. An apparatus according to claim 18, wherein the score includes a weighted combination of the similarities.

20. An apparatus according to claim 18, wherein the apparatus is further caused to:
determine to receive confirmation of the visit based on detection of presence of a user equipment of the user at the geographical item.
